(19) United States
(12) Patent Application Publication
(10) Pub. No.: US 2019/0184213 A1
(43) Pub. Date: Jun. 20, 2019

(54) HARNESS AND BELT

(71) Applicant: STEVEN HILL, SANDY, UT (US)

(72) Inventor: STEVEN HILL, SANDY, UT (US)

(21) Appl. No.: 15/843,769

(22) Filed: Dec. 15, 2017

(51) Int. Cl. A62B 35/00; A41F 9/00

(52) U.S. Cl. CPC A62B 35/0006; A41F 9/002

(57) ABSTRACT

A wearable harness system manually configurable as a belt and a climbing harness includes an elongated flexible belt body portion having a first end and a second end defining a front belt surface and a rear belt surface, a buckle attached to the first end, a pair of elongated leg straps attached to the rear belt surface, each of which configured to form a loop around each leg of a user, and an opening provided on the rear belt surface to form a pocket along a length of the elongated flexible belt body portion to store a portion of the pair of elongated leg straps. The wearable harness system may enable the users to conceal a portion of the pair of elongated leg straps inside the pocket prior to using the wearable harness system as the belt for fastening around a clothing item worn over a waist of the user.

### BACKGROUND OF THE INVENTION

### Field of the Invention

The present invention relates generally to a wearable harness system. More specifically, the present invention relates to a wearable harness system that can be transformed to a belt potentially having a hidden pocket for concealing a portion of a climbing harness part of the wearable harness system.

### Description of the Related Art

Different types of harnesses are used to inter-couple a user with some form of safety line such as a rope or cable. The most common type of harness used in outdoor activities is coupled around a user's waist and legs. A first part of these types of harness is wearable around the waist of the user like a belt and a second personal supportive part of the harness is made into a loop to wear around the legs at the torso area of the user. In various outdoor activities such as support and rescue activities, sports, a harness is used as a protective and supportive measure during ascent and descent of technical terrain. For example, in rope climbing related activities, an individual generally wears a harness around the legs and back portion at the torso area to act as seat or support and also to provide a coupling point for the rope. Likewise, during roped descents and rappels, a harness is necessary to facilitate the controlled rope descent.

Climbers, firemen, linemen, handymen, military personnel and the like use many types of climbing harnesses. The widely used type of the climbing harnesses includes a strong belt configured to wound around the waist of the user and one or more straps that can be formed into the shape of loops to wear around the legs and back of the user to provide proper support and protection during the climbing operations. Climbers such as rock climbers and other workers such as fireman, linemen, and handymen can wear these climbing harnesses to conduct steep climbing and down rappels through buildings, cliffs or steep mountainous terrain. The existing climbing harnesses are bulky and difficult to wear as the straps may get caught up during normal walking and other support operations. In addition, one of the common problems with conventional harness systems is the inefficient process required to engage and remove the harness from a user's body, every time after use. In some climbing harnesses, the straps for forming the support loops or lanyards can be taken off the belt portion to prevent the lanyards hanging from the belt getting tangled when the climbing harnesses is not in use. The user can reattach the straps forming the support loops or lanyards when the need arises. However, the removal and reattachment of the straps forming the support loops or lanyards is inefficient and time consuming. Hence, there exists a need for a harness system that can be transformed into a comfortable wearable form such as belt after its use as a harness.

Prior art attempts have been made to provide belts that can be converted between a belt-only configuration and a harness configuration in which leg loops are suspended from the belt to cooperate therewith to form a sit harness for climbing, rappelling or other ascending, descending, hanging or suspending operations. The following prior arts are hereby incorporated by reference for their supportive teachings of the present invention.

Several related art patents disclose wearable harnesses that can be transformed into other shapes after regular use, wherein the following patents are herein incorporated by reference for their supportive teaching for the present invention, and include the following:

One such prior art is disclosed in U.S. Pat. No. 6,481,528 titled “Combination utility belt and climbing harness” issued to Ishmael L. Antonio. The prior art discloses a dual belt system having a load-bearing or utility belt as well as a climbing harness waist band. An inner belt is a waistband for a climbing harness, the other outer belt being any typical load bearing belt, such as a military gear belt. The inner harness waistband and the load bearing belt are connected together by a series of releasable loops upon the waistband that may be opened to allow the load bearing belt to be separated from the harness. The loops may be closed and secured, as by fasteners, around a load bearing belt to temporarily connect together the harness waistband and the load bearing belt, so that they functional as an integral unit. The dual belt system is also provided with leg loops, permanently attached to the waistband of the harness, with which a true pelvis-girdling climbing harness may be assembled. The leg loops are stowed in a special pouch on the waistband until such time as they are deployed for use. However, the dual belt system disclosed by the above prior art cannot be easily transformed into a regular belt, when not in use as a harness, for fastening around the waist of the user and to support the clothing such as trousers worn around the waist of the user.

Another prior art, U.S. Pat. No. 9,027,707 titled “Convertible safety harness” issued to Honeywell International Inc. discloses an upper body harness portion for converting a seat-style harness to a full body harness. The upper body harness portion includes a front lower component, a rear lower component, and an upper torso component having elongated first, second and third webbings. The ends of the first and second webbings are detachably securable to opposite sides of the front and rear or side portions of the seat-style harness waist belt, respectively. The third webbing forms a closed loop which, when worn, extends over a wearer's shoulders on opposite sides of the wearer's head. First and second connectors are slidably connected to the third webbing, with the first connector also being slidably connected to the first webbing adjacent the front of a wearer and the second connector being slidably connected to the second webbing adjacent the back of a wearer. However, the upper body harness portion is not manually configurable to a wearable belt when not used as a harness for supporting the body of the user.

Yet another prior art, U.S. Pat. App. No. 20130191970 A1 titled “Belt having a retracting lanyard and a hidden pocket” filed by James Frederick Foreman discloses a belt having a retracting lanyard built into it for convenient deployment of an attachment device attached to the lanyard. The lanyard can be contained within the belt when not in use and can be extended therefrom for use. A stop prevents the lanyard from being removed from the belt and, therefore, the lanyard never needs to come off the belt. Because the lanyard retracts into a channel or slot in the belt, it does not get tangled and hung up. The belt can also include a hidden pocket to store money, notes, maps and the like. The attachment device can be stored in an attachment pouch when not in use, keeping the attachment device ready for use and preventing it from getting caught when not in use. However, the belt disclosed in the above prior art doesn't disclose a method for retrievably storing the straps of a harness for supporting the user when used as a harness for climbing and descending purposes.

There are several prior arts, which are also incorporated by reference for their supportive teachings, which disclose belts and harnesses having pockets built into it for storing objects such as safety tools and other items during use. One such prior art is disclosed in U.S. Pat. No. 8,235,173 B2 titled “Single waistband belt system convertible between a sit harness and quick release utility belt” issued to Christopher Kopp. The prior art discloses a belt system convertible into and out of a sit harness configuration for selective use as a harness or a utility belt features a pair of leg loops and a waistband equipped with a quick release buckle. Support straps projecting from the leg loops are arranged for releasable engagement to the waistband and releasable engagement to one another so that the releasable engagement to one another when also engaged to the waistband provides a second closure thereof so that the waistband remains closed by the connection between the support straps even if the quick release buckle on the waistband is inadvertently disengaged. Using only a single waistband, the belt system provides a quick release function when used only as a utility belt, yet avoids the hazard of having the waistband open by inadvertent release of the quick release waistband buckle during use as a harness. However, the configuration between belt and harness is not easy and time consuming.

Hence there exists a need for an improved wearable harness system that would be able to easily transformable between a belt and a harness. The needed wearable harness system would be easy to wear as a belt during normal use, aesthetically pleasing, and would provide the functionality of a harness system during climbing and other activities.

### SUMMARY OF THE INVENTION

The present invention relates to a wearable harness system capable of manually configured to function in form of a belt for a clothing item and as a climbing harness, according to one or more implementations of the present invention. The present wearable harness system includes an elongated flexible belt body portion having a first end and a second end defining a front belt surface and a rear belt surface, a buckle capable of functioning as a fastener attached to the first end of the elongated flexible belt body portion, a pair of elongated leg straps, each configured to form a loop around each leg of a user, attached to the rear belt surface of the elongated flexible belt body portion and an opening provided on the rear belt surface to form a pocket along a length of the elongated flexible belt body portion to store a portion of the pair of elongated leg straps. The wearable harness system enables the users to conceal a portion of the pair of elongated leg straps inside the pocket provided on the rear belt surface prior to using the wearable harness system in form of the belt for fastening around the clothing item worn over a waist of the user.

The present invention also discloses a method of using the wearable harness system in form of a belt for a clothing item, according to one or more implementations of the present invention. The method includes the steps of providing the wearable harness system having the elongated flexible belt body portion with the first end attached to the buckle and the second end, a pair of elongated leg straps attached to the rear belt surface of the elongated flexible belt body portion and the pocket formed on the rear belt surface for storing a portion of the pair of elongated leg straps. The method of transforming and using the wearable harness system in form of the belt follows the steps of arranging the elongated leg straps hanging from a flexible strip attached to the rear belt surface, proximate to the buckle, to form an elongated flat strap, inserting a distal portion of the elongated leg straps arranged in form of the elongated flat strap into the pocket formed along a length of the elongated flexible belt body portion through the opening provided on the rear belt surface, which leads into an interior of the pocket, pushing the elongated leg straps arranged in form of the elongated flat strap into the pocket until the elongated flat strap gets completely stretched and concealed behind the rear belt surface and securing the portion of the pair of elongated leg straps inserted into the pocket using a removable fastener to form the belt. The belt thus formed can be fastened around the clothing item worn over the waist of the user by passing the second end of the elongated flexible belt body portion through a number of belt loops provided on the clothing item and thereafter through an opening of the buckle to form an adjustable loop of desired size. The loop of desired size thus formed around the waist of the user, over the clothing, is secured using a fastener associated with the buckle. The pocket is formed along a length of the elongated flexible belt body portion to store a portion of the pair of elongated leg straps arranged in form of the elongated flat strap.

The present invention also discloses a method for transforming the wearable harness system from the belt form into a form of a climbing harness. The method includes the steps of providing the wearable harness system in shape of the belt with a portion of the pair of elongated leg straps secured inside the pocket concealed behind the rear belt surface of the elongated flexible belt body portion. The portion of the pair of elongated leg straps secured inside the pocket is then detached by releasing the removable fastener securing the portion of the pair of elongated leg straps to the pocket. The pair of elongated leg straps is then released from the pocket by manually pulling the straps out of the pocket to form a pair of loops. Each of the loops is then passed through the legs of the user and arranged near the pelvic area of the user. The elongated flexible belt body portion of the wearable harness system is then wound around the waist of the user, over the clothing, just like wearing the belt around the waist of the user. The elongated flexible belt body portion is fastened around the waist of the user by passing the second end of the elongated flexible belt body portion through a number of belt loops provided on the clothing worn by the user and thereafter through the opening of the buckle positioned on a front portion or front side of the user. Thus the wearable harness system can be transformed from the belt shape into the climbing harness shape.

Other features and other main features of the present invention are discussed below. The present invention is designed to fulfill the below and other additional features as detailed in the following claims section and detailed description section of the invention.

A primary feature of the invention provides a wearable harness system capable of manually configured to function in form of a belt for a clothing item and as a climbing harness.

A second feature of the present invention provides a wearable harness system manually configurable to function in form of a belt by concealing straps provided for using the wearable harness system as a climbing harness.

A third feature of the present invention provides a wearable harness system that can be easily transformed between a belt and a climbing harness.

Another feature of the present invention provides a belt for use as a fastener for clothing worn around the waist of a user.

Another feature of the present invention provides a climbing harness that can be used for safely performing climbing and other activities.

These together with other features of the invention, along with the various features of novelty, which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 illustrates a front perspective view of the wearable harness system capable of being manually configured to function in form of a belt for a clothing item and a climbing harness, according to a preferred embodiment of the present disclosure;

FIG. 2 illustrates a front perspective view of the wearable harness system, manually configured to function in form of a climbing harness, worn around the legs and waist of a user, according to a preferred embodiment of the present disclosure;

FIG. 3A illustrates a rear view of the wearable harness system manually configured to function in form of a belt for a clothing item, according to a preferred embodiment of the present disclosure;

FIG. 3B illustrates a front perspective view of the wearable harness system manually configured to function in form of a belt for a clothing item, according to a preferred embodiment of the present disclosure;

FIG. 4 illustrates a front perspective view of the wearable harness system, manually configured to function in form of a belt, fastening a clothing item worn around the waist of a user, according to a preferred embodiment of the present disclosure;

FIG. 5 is a flowchart showing a method for utilizing the wearable harness system in form of a belt for a clothing item, according to a preferred embodiment of the present invention; and

FIG. 6 is a flowchart showing a method for utilizing the wearable harness system in form of a climbing harness, according to a preferred embodiment of the present invention.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the present disclosure.

Further, various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiment of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

Further the following section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure.

The present invention relates to a wearable harness system having a belt part and a climbing harness part. In particular, the present invention relates to a wearable harness system that can be easily transformed between a belt and a climbing harness, according to a preferred embodiment of the present invention. According to a preferred embodiment of the present invention, the wearable harness system is provided with a pocket, along a length of a flexible strap forming a part of the wearable harness system, to conceal a portion of a climbing harness part of the wearable harness system. The present wearable harness system enables the users to easily switch from the belt fastener use to the climbing harness thereby saving time and ensuring efficient deployment of the climbing harness, whenever in need. Furthermore, the present wearable harness system is transformable into the belt for use with regular clothing.

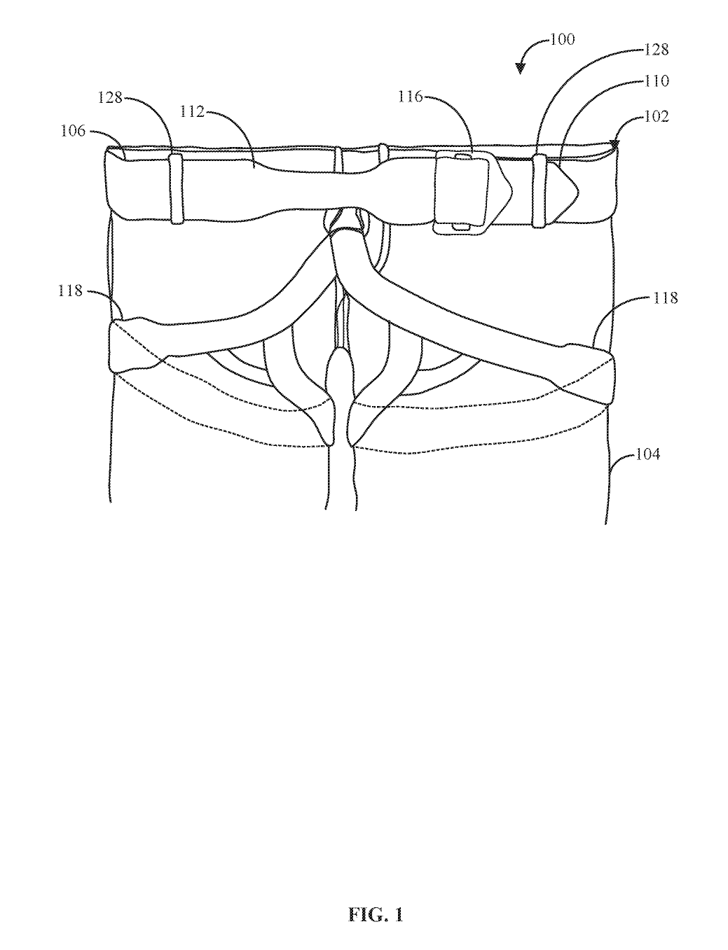

FIG. 1 illustrates a front perspective view of the present wearable harness system 100 capable of being manually configured to function in form of a belt 102 for a clothing item 104 and a climbing harness, according to a preferred embodiment of the present disclosure. The present wearable harness system 100 configurable between the belt 102 form and the climbing harness form includes an elongated flexible belt body portion 106 having a first end 108 and a second end 110 defining a flat elongated strap, according to a preferred embodiment of the present invention. The elongated flexible belt body portion 106 formed in shape of a flat elongated strap having a front belt surface 112 and a rear belt surface 114 is made from strong, flexible materials such as, but not limited to, leather, clothing straps, webbing, Kevlar, a combination of materials forming a dense webbing structure etc. In some instance, the elongated flexible belt body portion 106 having the front belt surface 112 and the rear belt surface 114, bounded between the first end 108 and the second end 110, is provided with an uneven surface at the front belt surface 112 and the rear belt surface 114.

The first end 108 of the elongated flexible belt body portion 106 is attached with a buckle 116. In some implementations, the buckle 116 is attached to the first end 108 of the elongated flexible belt body portion 106 using attaching methods such as, but not limited to, stitching, clips and/or a pin. Further, in some other implementation of the present invention, the buckle 116 is permanently attached to the first end 108 of the elongated flexible belt body portion 106, whereas in some other instances, the buckle 116 is removably attached to the first end 108 of the elongated flexible belt body portion 106. Further some instance, the buckle 116 is provided with an opening configured to pass the second end 110 of the elongated flexible belt body portion 106 and a portion of a length of the elongated flexible belt body portion 106 to form a loop of desired size. In some other instances, the buckle 116 is provided with a fastener to realizably secure a position of the elongated flexible belt body portion 106 passed through the opening of the buckle 116 and forming the loop around the waist of a user. In some other instances, a portion of the elongated flexible belt body portion 106 configured to pass through the opening on the buckle 116 is provided with a reception mechanism to engage with the fastener provided on the buckle 116. This ensures the users to securely wear the present wearable harness system 100 transformed into the belt 102 or transformed into the climbing harness around the waist of the user.

The present wearable harness system 100 further includes a pair of elongated leg straps 118, each configured to form a loop around each leg of a user, according to a preferred embodiment of the present disclosure. The pair of elongated leg straps 118 are attached to the rear belt surface 114 of the elongated flexible belt body portion 106 using a flexible strip 124 of material. In some instance, the flexible strip 124 for attaching the pair of elongated leg straps 118 forming the pair of loops around the legs of the user, during the climbing harness use of the present wearable harness system 100, is a string or a strip of clothing or a nylon rope. According to a preferred embodiment, the flexible strip 124 attaching the pair of elongated leg straps 118 is fixed to the rear belt surface 114 of the elongated flexible belt body portion 106, proximate to the buckle 116, using attaching methods such as, but not limited to, stitching, clips, pins and/or any mechanical attachment method. Further, according to preferred embodiment, the flexible strip 124 attaches the pair of elongated leg straps 118 to the rear belt surface 114 of the elongated flexible belt body portion 106 in such a way that the loops formed by the pair of elongated leg straps 118 freely hangs from the flexible strip 124 to enable the users to easily wear the loops around their individual legs during a climbing harness use of the present wearable harness system 100. The pair of elongated leg straps 118 forming the pair of loops is formed from strong flexible materials selected from a group consisting of, but not limited to, leather, clothing straps, webbing, Kevlar, a combination of materials forming a dense webbing structure etc. In some instances, the pair of elongated leg straps 118 forming the pair of loops is manually adjustable to change a size of the loop for comfortably wearing around the legs of the users.

The present wearable harness system 100 further includes an opening 120 provided on the rear belt surface 114 to form a pocket 122 along a length of the elongated flexible belt body portion 106 to store a portion of the pair of elongated leg straps 118, according to a preferred embodiment of the present invention. The pocket 122 provided on the rear belt surface 114, along a length of the elongated flexible belt body portion 106, enables the users to conceal a portion of the pair of elongated leg straps 118 inside the pocket 122 and transform the wearable harness system 100 in form of the belt 102 for fastening around the clothing item worn over the waist of the user. The users can first arrange the pair of elongated leg straps 118 together and insert a distal portion of the elongated leg straps 118 through the opening 120 of the pocket 122 provided on the rear belt surface 114. Then the users can push the rest of the portion of the pair of elongated leg straps 118 into the pocket 122 extending along the length of the elongated flexible belt body portion 106 until the pair of elongated leg straps 118 gets completely concealed behind the rear belt surface 114 of the elongated flexible belt body portion 106. The portion of the pair of elongated leg straps 118 inserted into the pocket 122 is secured using a removable fastener 126 provided near the opening 120 on the rear belt surface 114. In certain instances, the removable fastener 126 provided near the opening 120 on the rear belt surface 114 for securing the portion of the pair of elongated leg straps 118 inside the pocket 122 is selected from Velcro, pins, hooks or a button. The removable fastener 126 provided near the opening 120 of pocket 122 provided on the rear belt surface 114 ensures that the pair of elongated leg straps 118 gets completely concealed behind the rear belt surface 114 of the elongated flexible belt body portion 106 during the use of the present wearable harness system 100 as a belt 102. Further, in certain instances, the pocket 122 is formed inside the elongated flexible belt body portion 106 and accessible through the opening 120 provided at the rear belt surface 114 to store the portion pair of elongated leg straps 118 along the length of the elongated flexible belt body portion 106. In some other instances, the pocket 122 is formed by attaching a separate clothing or material to the rear belt surface 114 of the elongated flexible belt body portion 106 using stitching, gluing or other attachment methods.

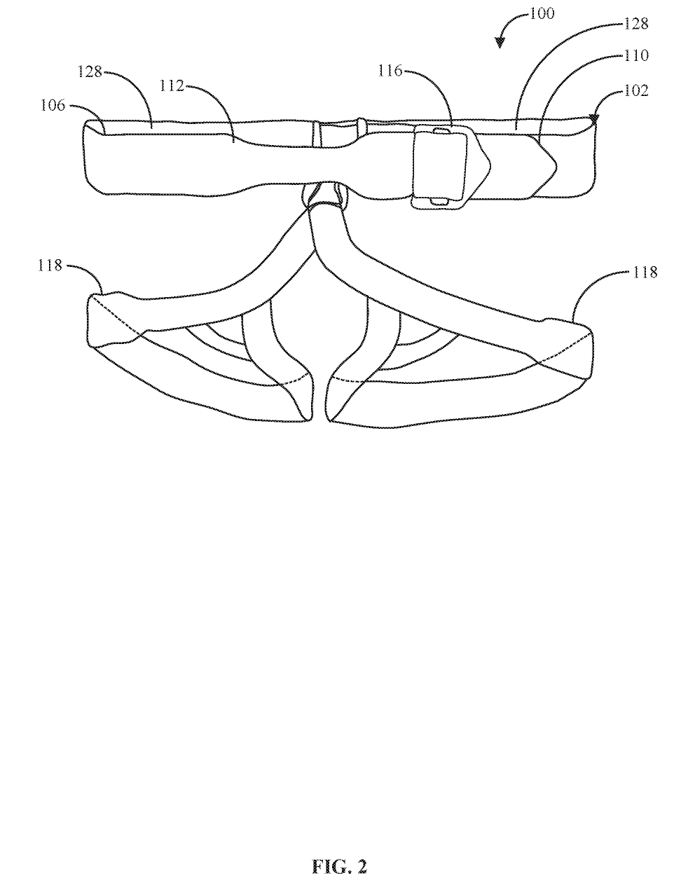

FIG. 2 illustrates a front perspective view of the wearable harness system 100, manually configured to function in form of the climbing harness, worn around the legs and waist of a user, according to a preferred embodiment of the present disclosure. The present wearable harness system 100, with the pair of elongated leg straps 118 freely hanging from the from the flexible strip 124 attached to the rear belt surface 114 of the elongated flexible belt body portion 106, enables the users to first insert each leg through the loop formed by each of the elongated leg straps 118. The users can insert the legs through loops keeping the buckle 116 of the wearable harness system 100 at the front of the user. The users can manually adjust the pair of elongated leg straps 118 to wear around both the legs at the pelvic area of the user. Once the user wears the pair of elongated leg straps 118, he/she can fasten the elongated flexible belt body portion 106 of the wearable harness system 100 using the buckle 116. In some instance, the user can first pass the second end 110 and the rest of the portion of the elongated flexible belt body portion 106 through each of the belt loops 128 provided on the trousers or pants or any other clothing type, prior to fastening the elongated flexible belt body portion 106 around the waist of the user. The climbing harness mode of use of the present wearable harness system 100 thus formed enables the users to attach special climbing gear such as hooks and other releasable fasteners onto the elongated flexible belt body portion 106. In some instance, the buckle 116 is provided with provisions to attach the releasable fasteners provided with the climbing rope. In some other instance, the elongated flexible belt body portion 106 is provided with provisions to attach the releasable fasteners provided with the climbing rope for enabling easy and efficient use of the present wearable harness system 100 as a climbing harness. In some other instance, the flexible strip 124 attaching the pair of elongated leg straps 118 to the rear belt surface 114 of the elongated flexible belt body portion 106 functions as an engaging point for the releasable fasteners provided with the climbing rope.

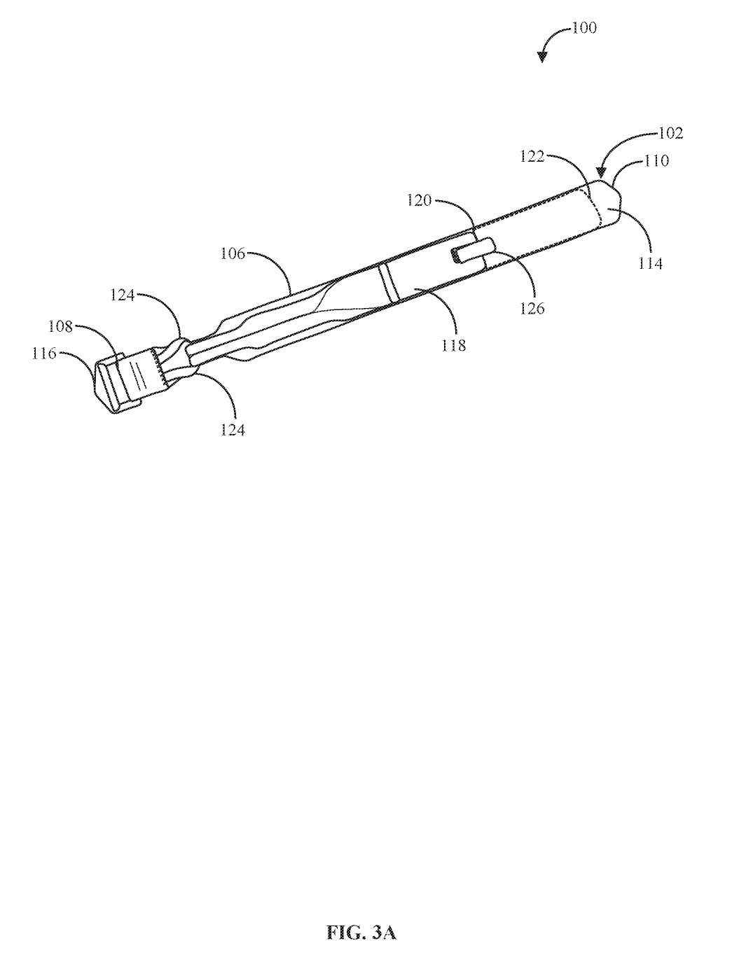

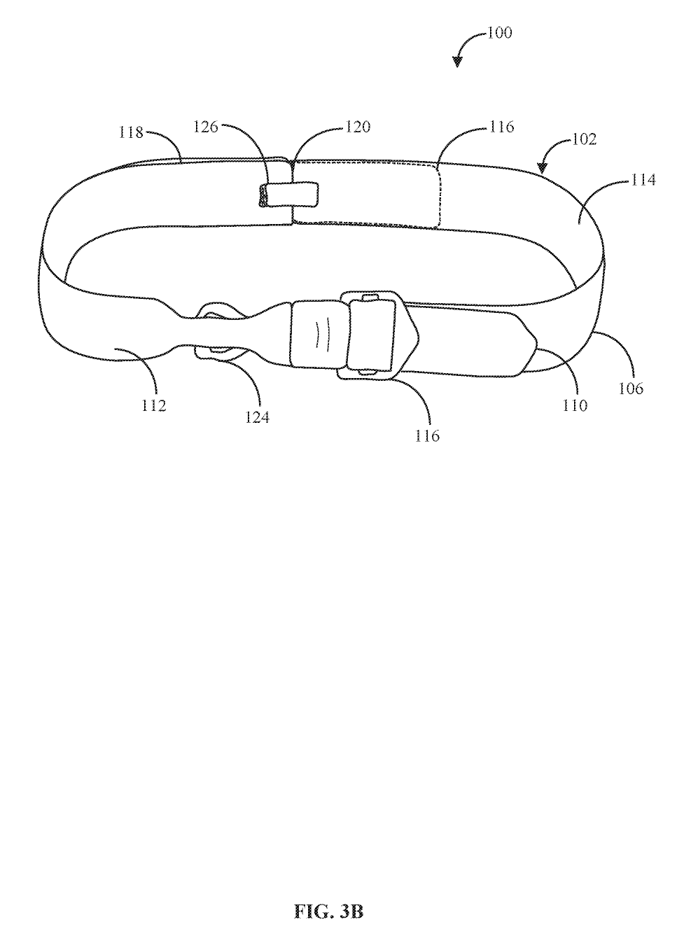

FIG. 3A illustrates a rear view of the wearable harness system 100 manually configured to function in form of the belt 102 for a clothing item, according to a preferred embodiment of the present disclosure. In order to transform the wearable harness system 100 into the belt 102, the pair of elongated leg straps 118 attached to the rear belt surface 114 of the elongated flexible belt body portion 106 using the flexible strip 124 is arranged together. The distal end of the pair of elongated leg straps 118 is then inserted through the opening 120 of the pocket 122. The elongated leg straps 118 are then manually passed through the space formed inside the pocket 122, along the length of the elongated flexible belt body portion 106, until the elongated leg straps 118 is completely stretched and gets concealed behind the rear belt surface 114 of the elongated flexible belt body portion 106. In some instance, the rear belt surface 114 of the elongated flexible belt body portion 106 is provided with one or more loops to pass the elongated leg straps 118 prior to securing a portion of the elongated leg straps 118 into the pocket 122, which prevents accidental revealing or falling down of the elongated leg straps 118. In some other instance, one or both the elongated leg straps 118 is provided with a removable fastener selected from a group consisting of Velcro, pins, hooks and a button to engage with its complementary part provided on the rear belt surface 114 proximate to the opening 120. This ensures the elongated leg straps 118 to be completely concealed during the use of the present wearable harness system 100 as a belt 100.

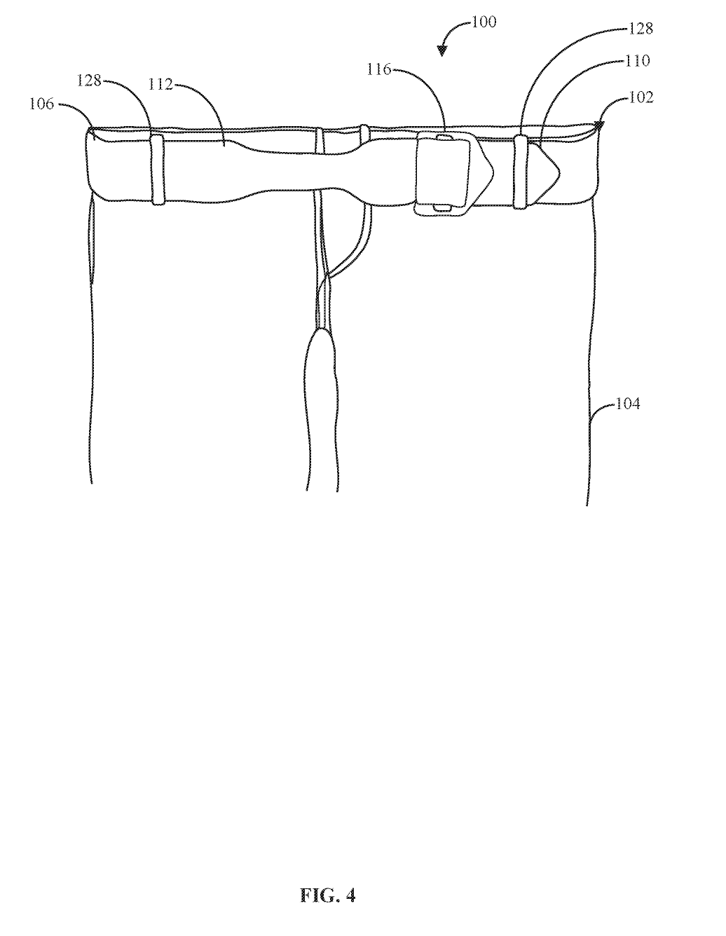

FIG. 3B illustrates a front perspective view of the wearable harness system 100 manually configured to function in form of the belt 102 for a clothing item, according to a preferred embodiment of the present disclosure. Once the wearable harness system 100 is transformed into a belt 102 as in FIG. 3A, the users can pass the second end 110 of the elongated flexible belt body portion 106, keeping the buckle 116 at the front, through the belt loops 128 provided on the clothing worn around the waist of the user. Now the elongated flexible belt body portion 106 can be formed into a loop around the waist of the user over the clothing by passing the second end 110 of the elongated flexible belt body portion 106 until a comfortable fitting belt loop is formed around the waist of the user. The elongated flexible belt body portion 106 forming the comfortable fitting belt loop around the waist of the user is secured using the fastener provided with the buckle 116. FIG. 4 illustrates a front perspective view of the wearable harness system 100, manually configured as the belt 102, fastening the clothing item worn around the waist of the user, according to a preferred embodiment of the present disclosure. The elongated flexible belt body portion 106 completely conceals the pair of elongated leg straps 118 between the clothing and the rear belt surface 114 of the elongated flexible belt body portion 106. Thus the present wearable harness system 100 can be configured as a normal belt 102 for use with many of the clothing types such as pants, shorts, etc., which can instantly be transformed into the climbing harness.

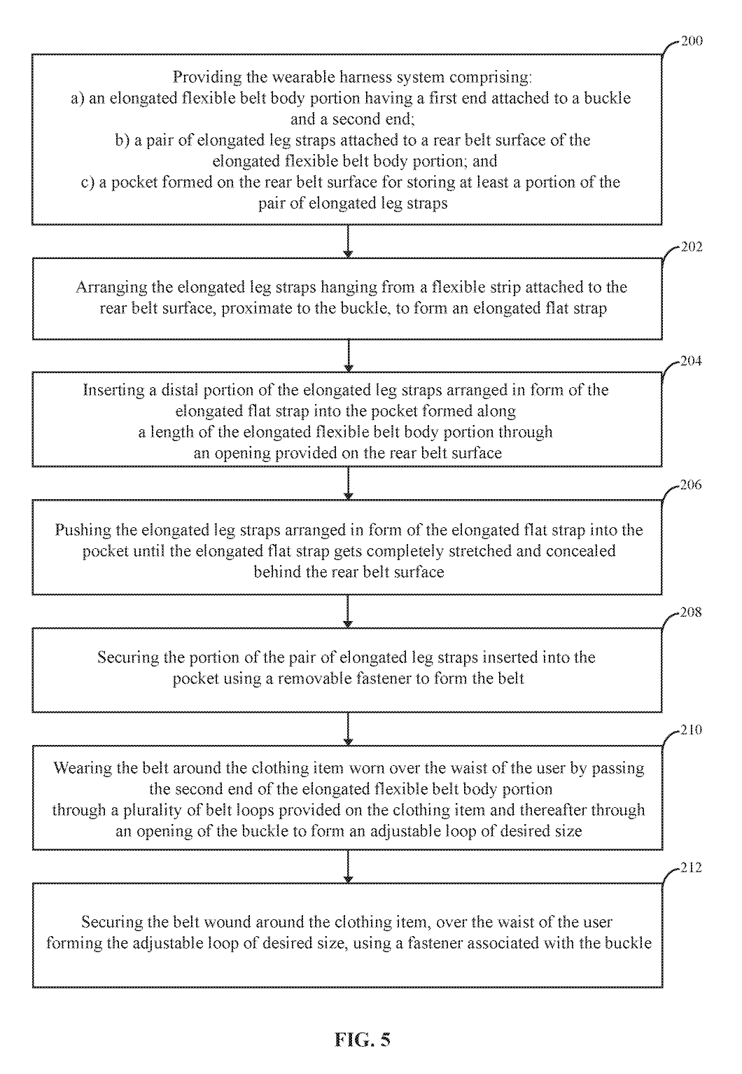

FIG. 5 is a flowchart showing a method for utilizing the wearable harness system 100 in form of a belt 102 for a clothing item, according to a preferred embodiment of the present invention. The method of using the present wearable harness system 100 as a belt 102 for a clothing item 104 start with the step of providing the wearable harness system 100, as in block 200. As explained in the previous paragraphs, the present wearable harness system 100 includes the elongated flexible belt body portion 106 having the first end 108 attached to the buckle 116 and the second end 110 configured to pass through the opening of the buckle 116, the pair of elongated leg straps 118 attached to the rear belt surface 114 of the elongated flexible belt body portion 106 using the flexible strips 124 and the pocket 122 formed on the rear belt surface 114 for storing at least a portion of the pair of elongated leg straps 118. Now as in step 202, the elongated leg straps 118 hanging from the flexible strip 124 attached to the rear belt surface 114 are arranged together to form an elongated flat strap. The distal portion or distal end of the elongated flat strap thus formed is passed through the opening 120 of the pocket 122 as in block 204. Now as in block 206, the elongated flat strap inserted through the opening 120 of the pocket 122 is manually moved to the inside space of the pocket 122 until the elongated flat strap gets completely stretched and concealed behind the rear belt surface 114. Once the pair of elongated leg straps 118 is completely stretched behind the rear belt surface 114 of the elongated flexible belt body portion 106, the portion of the elongated leg straps 118 inside the pocket 122 is secured using the fastener, such as Velcro, as in block 208. Now as in block 210, the belt 102 thus formed from the wearable harness system 100 is worn over the waist of the user by passing the second end 110 of the elongated flexible belt body portion 106 through the belt loops and the opening of the buckle 116. The belt 102 wound around the clothing item, worn over the waist of the user, forming the adjustable loop of desired size is secured using the fastener associated with the buckle 116, as in block 212.

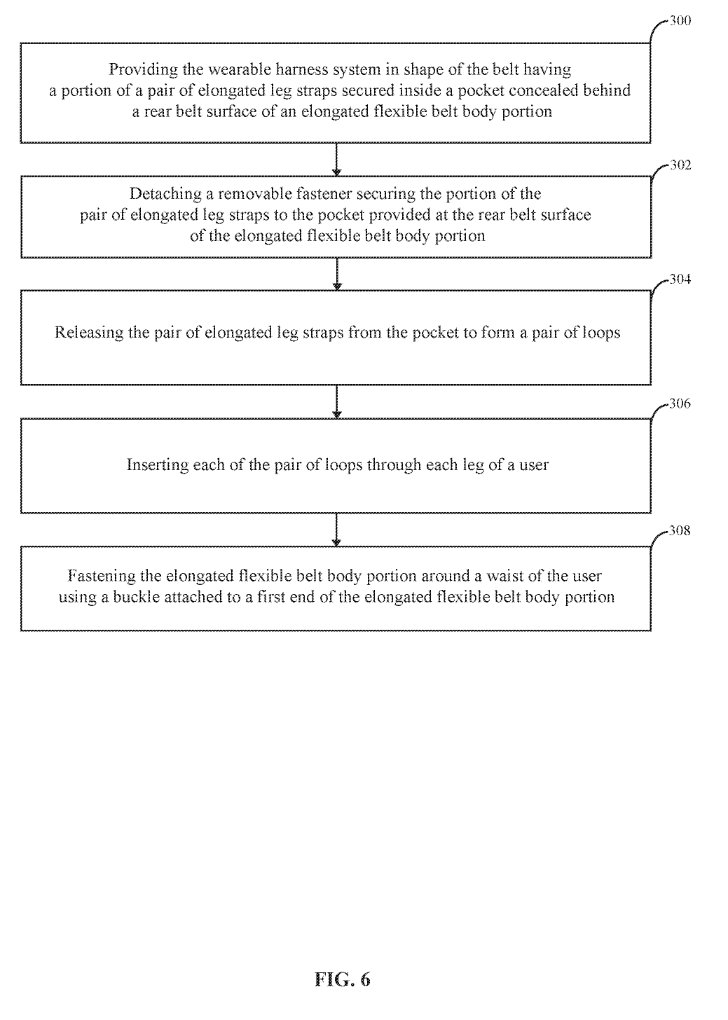

FIG. 6 is a flowchart showing a method for transforming the wearable harness system 100 from the shape of the belt 102 into the form of a climbing harness, according to a preferred embodiment of the present invention. The method for transforming the wearable harness system 100 from the belt 102 shape to a climbing harness includes the steps of providing the wearable harness system 100 in shape of the belt 102 with a portion of the pair of elongated leg straps 118 secured inside the pocket 122 concealed behind the rear belt surface 114 of the elongated flexible belt body portion 106 as in block 300. Now as in block 302, the removable fastener 126 securing the portion of the pair of elongated leg straps 118 inserted into the pocket 122 is detached. After this the user can release the pair of elongated leg straps 118 from the pocket 122 to form a pair of loops, as in block 304. Now as in block 306, the users can insert each of their leg through each of the loops to receive support while climbing. The uses can now fasten the elongated flexible belt body portion 106 around the waist using the buckle 116 attached to the first end 108 of the elongated flexible belt body portion 106, as in block 308. The elongated flexible belt body portion 106 is fastened around the waist of the user by passing the second end 110 of the elongated flexible belt body portion 106 through the belt loops 128 provided on the clothing worn by the user and thereafter through the opening of the buckle 116 positioned on a front side of the user. In some implementations of the present invention, the flexible strip 124 attaching the pair of elongated leg straps 118 to the rear belt surface 114 of the elongated flexible belt body portion 106 can be utilized as a hook for engaging with the releasable fastener provided with the climbing ropes, during the climbing and other activates performed by the user.

It is noted that there are many variations to the present invention. Specifically, although the provided description discusses the use of a pocket 122 to potentially house portions of the harness, one skilled in the art will easily understand that a pocket may be optional, and that portions of the harness may be made of elastic-type material that will hold or retract the appropriate parts thereof sufficiently to be located for the belt functionality.

Further, it should be noted that the steps described in the method of use could be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, technological advances, etc., other methods of use arrangements, elimination or addition of certain steps, including or excluding certain maintenance steps, etc., may be sufficient.

It is noted that the present descriptions and drawings illustrate specific embodiments, however many variations may be encompassed and understood by skilled artisans of climbing harness makers. For example, the illustration of a belt and harness may be made of any material, with any reasonable dimensions, shapes, diameters, and thicknesses and do not have to be a flat material as such.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A wearable harness system capable of being manually configured to function in form of a belt for a clothing item and a climbing harness, comprising:
a) an elongated flexible belt body portion having a first end and a second end defining a front belt surface and a rear belt surface;
b) at least one buckle attached to the first end of the elongated flexible belt body portion;
c) a pair of elongated leg straps, each configured to form a loop around each leg of a user, attached to the rear belt surface of the elongated flexible belt body portion; and
d) at least one opening provided on the rear belt surface to form a pocket along a length of the elongated flexible belt body portion to store at least a portion of the pair of elongated leg straps;
whereby the wearable harness system enables the users to conceal at least a portion of the pair of elongated leg straps inside the pocket provided on the rear belt surface prior to using the wearable harness system in form of the belt for fastening around the clothing item worn over a waist of the user.

2. The wearable harness system of claim 1 wherein the buckle is attached to the first end of the elongated flexible belt body portion using stitching, clips and/or a pin.

3. The wearable harness system of claim 1, wherein the buckle is provided with at least one opening configured to receive the second end and at least a portion of the elongated flexible belt body portion to form a loop of desired size,
wherein the buckle is configured to function in form a fastener to secure the loop having a desired size formed by the elongated flexible belt body portion around the clothing item worn over the waist of the user.

4. The wearable harness system of claim 1, wherein the pair of elongated leg straps, each configured to form individual loops around each leg of the user, is attached to the rear belt surface, proximate to the buckle, of the elongated flexible belt body portion using at least one flexible strip.

5. The wearable harness system of claim 4, wherein the flexible strip is attached to the rear belt surface, proximate to the buckle, of the elongated flexible belt body portion using stitching, clips and/or any mechanical attachment tool.

6. The wearable harness system of claim 1, wherein the pair of elongated leg straps freely hangs down from the flexible strip attached to the rear belt surface, proximate to the buckle, to wear around the legs of the user during use in form of the climbing harness.

7. The wearable harness system of claim 1, wherein the portion of the pair of elongated leg straps inserted through the opening into the pocket stretches along the length of the elongated flexible belt body portion,
wherein the pair of elongated leg straps are concealed behind the rear belt surface during use of the wearable harness system in form of the belt for fastening around the clothing item worn over the waist of the user.

8. The wearable harness system of claim 1, wherein the portion of the pair of elongated leg straps inserted into the pocket is secured using a removable fastener selected from a group consisting of Velcro, pins, hooks and a button.

9. The wearable harness system of claim 1, wherein the pocket is formed inside the elongated flexible belt body portion and accessible through the opening provided at the rear belt surface to store the portion pair of elongated leg straps along the length of the elongated flexible belt body portion.

10. The wearable harness system of claim 1, wherein the pocket is attached to the rear belt surface of the elongated flexible belt body portion using stitching and/or gluing.

11. The wearable harness system of claim 1, is made from flexible, durable materials selected from a group consisting of leather, nylon, Kevlar, and a combination of materials forming a dense webbing structure.

12. A method of using a wearable harness system capable of being manually configured to function in form of a belt for a clothing item, comprising the steps of:
a) providing the wearable harness system comprising:
an elongated flexible belt body portion having a first end attached to a buckle and a second end;
a pair of elongated leg straps attached to a rear belt surface of the elongated flexible belt body portion; and
a pocket formed on the rear belt surface for storing at least a portion of the pair of elongated leg straps;
b) arranging the elongated leg straps hanging from a flexible strip attached to the rear belt surface, proximate to the buckle, to form an elongated flat strap;
c) inserting a distal portion of the elongated leg straps arranged in form of the elongated flat strap into the pocket formed along a length of the elongated flexible belt body portion through an opening provided on the rear belt surface;
d) pushing the elongated leg straps arranged in form of the elongated flat strap into the pocket until the elongated flat strap gets completely stretched and concealed behind the rear belt surface;
e) securing the portion of the pair of elongated leg straps inserted into the pocket using a removable fastener to form the belt;
f) wearing the belt around the clothing item worn over the waist of the user by passing the second end of the elongated flexible belt body portion through a plurality of belt loops provided on the clothing item and thereafter through an opening of the buckle to form an adjustable loop of desired size; and
g) securing the belt wound around the clothing item, over the waist of the user forming the adjustable loop of desired size, using a fastener associated with the buckle.

13. The method of claim 12, wherein the pocket is formed along a length of the elongated flexible belt body portion to store at least a portion of the pair of elongated leg straps arranged in form of the elongated flat strap.

14. A method for transforming a wearable harness system from a belt into a form of a climbing harness, comprises the steps of:
a) providing the wearable harness system in shape of the belt having a portion of a pair of elongated leg straps secured inside a pocket concealed behind a rear belt surface of an elongated flexible belt body portion;
b) detaching a removable fastener securing the portion of the pair of elongated leg straps to the pocket provided at the rear belt surface of the elongated flexible belt body portion;
c) releasing the pair of elongated leg straps from the pocket to form a pair of loops;
d) inserting each of the pair of loops through each leg of a user; and
e) fastening the elongated flexible belt body portion around a waist of the user using a buckle attached to a first end of the elongated flexible belt body portion.

15. The method of claim 14, wherein the elongated flexible belt body portion is fastened around the waist of the user by passing a second end of the elongated flexible belt body portion through a plurality of belt loops provided on a clothing worn by the user and thereafter through an opening of the buckle positioned on a front of the user.

16. The method of claim 14, wherein the pair of elongated leg straps is attached to the rear belt surface of the elongated flexible belt body portion using a flexible strip,
wherein the flexible strip functions in form of a hook for engaging with a releasable fastener provided with a climbing rope.
